(19) United States
(12) Patent Application Publication
(10) Pub. No.: US 2009/0046639 A1
(43) Pub. Date: Feb. 19, 2009

(54) System and Method for Handling Large IP Packets During VoIP Session

(76) Inventors: Zhijun Cai, Euless, TX (US); James Earl Womack, Bedford, TX (US)

Correspondence Address: RESEARCH IN MOTION;ATTN: GLENDA WOLFE, BUILDING 6, BRAZOS EAST, SUITE 100, 5000 RIVERSIDE DRIVE, IRVING, TX, 75039, US

(21) Appl. No.: 11/968,518

(22) Filed: Jan. 2, 2008

Related U.S. Application Data
(60) Provisional application No. 60/955,734, filed on Aug. 14, 2007.

(51) Int. Cl. H04Q 7/00; H04L 12/66

(52) U.S. Cl. 370/329; 370/352

(57) ABSTRACT

The application provides a logical channel design in which a first transmitted logical channel and a first received logical channel are used to send and receive compressed VoIP packets and uncompressed VoIP over a wireless link. A second transmitted logical channel and a second received logical channel are used to send and receive session control packets over the wireless link. The compressed VoIP packets utilize semi-persistent resource allocation whereas the uncompressed VoIP packets utilize dynamically scheduled resource allocation.

### RELATED APPLICATION

This application claims the benefit of U.S. Provisional Application Ser. No. 60/955,734 filed on Aug. 14, 2007 which is incorporated herein by reference in its entirety.

### FIELD

The application relates to transmission of packets such as VoIP packet using semi-persistently allocated transmission resources.

### BACKGROUND

Semi-persistent scheduling has been adopted in some applications for VoIP for both the uplink and downlink. With semi-persistent scheduling, for downlink VoIP (voice over IP (Internet Protocol)) communications to a mobile device, a periodic downlink transmission resource is allocated to be used each time voice needs to be sent over the air (OTA). The resource is turned on during the talk-spurts and off between talk-spurts. This eliminates the need to explicitly request an allocation, and receive a grant, each time voice needs to be sent. This is referred to as semi-persistent scheduling. Semi-persistent scheduling for uplink VoIP communications from a mobile device behaves much the same way. Semi-persistent scheduling is suitable for voice traffic which has constant rate characteristics, relatively periodic transmission intervals and small packet size variance; however, the payload capacity of semi-persistent scheduling does not allow the ability to include other infrequently occurring and much larger in size IP packets associated with the VoIP session (e.g., uncompressed VoIP, RTCP (RTP control protocol), and SIP/SDP (session initiation protocol/session description protocol) packets). The semi-persistent VoIP payload is typically transmitted in an RTP (real-time transmission protocol) payload.

Wireless communications often consider using packet header compression techniques to reduce the size of voice packets and increase spectral efficiency of the over-the-air link; indeed they also use voice codecs (such as Adaptive Multi-Rate) to reduce the size of the samples taken of a speakers voice for the same reason. Uncompressed VoIP packets can be as large as 95 bytes (assuming the 12.2 kbps rate of AMR (Adaptive Multi-Rate), a 10 bit AMR payload format header, 12 bytes of RTP header, 8 bytes of UDP (user datagram protocol) header, and 40 bytes IPV6 header). Using ROHC (Robust Header Compression), the payload can be reduced to 35-40 bytes with the header being reduced to around 2 bytes. ROHC is intended to reduce the size of most headers in a voice communication. However, there are circumstances, such as when errors occur in several consecutive packet OTA transmissions, the entire uncompressed VoIP packet is sent. Other times when uncompressed VoIP packet delivery may occur is at the beginning of a call and during handovers.

It is specified in RTP that RTCP (RTP control protocol) packets use a different IP port than their associated RTP packets that carry the voice payload. RTCP carries media control information between the endpoints. RTCP packets are of variable size and can be much larger than the RTP payload. For example, they can be as large as 200 bytes. The RTCP packets are transmitted rather infrequently (a minimum of every 5 seconds), and it has been suggested that the fraction of the session bandwidth allocated to RTCP be 5% of the total bandwidth for the combined RTP/RTCP flow in RFC1889. Many RTCP packets can tolerate a certain level of delay.

SIP/SDP messages are used for session control purposes. The size of an SIP/SDP message can be as much as several hundreds of bytes. Typical SIP message sizes are shown in following table:

| Message | SIZE |
|---|---|
| SIP INVITE (leaving MT1, with | 600 bytes |
| SDP) | |
| SIP INVITE (arriving MT1, | 800 bytes |
| with SDP) | |
| SIP 200 OK | 300 bytes |
| SIP ACK | 250 bytes |

Since the SIP/SDP is used for session control purposes, it should get high priority.

Another important issue is that the BLER (block error rate) requirements for the RTP (with voice payload) and RTCP/SIP/SDP may be different. Voice packets using RTP target 1% frame error rates (FER) but RTCP/SIP/SDP may have far stricter FER requirements.

### BRIEF DESCRIPTION OF THE DRAWINGS

Embodiments will now be described with reference to the attached drawings in which:

FIGS. 1 through 8 and 11 are flowcharts of methods of transmitting and receiving VoIP packets using semi-persistently allocated resources and sending and receiving uncompressed VoIP packets;

FIG. 9 is a block diagram of a wireless system; and

FIG. 10 is a block diagram of a mobile device.

### DETAILED DESCRIPTION

According to one broad aspect, the application provides a method comprising: sending and receiving compressed VoIP packets and uncompressed VoIP packets on a first transmitted logical channel and a first received logical channel over a wireless link; sending and receiving session control packets on a second transmitted logical channel and a second received logical channel over the wireless link; wherein sending and receiving the compressed VoIP packets utilizes semi-persistent resource allocation; and wherein sending and receiving uncompressed VoIP packets utilizes dynamically scheduled resource allocation.

According to another broad aspect, the application provides an apparatus comprising: a transmitter for transmitting compressed VoIP packets and uncompressed VoIP packets on a first transmitted logical channel over a wireless link and for transmitting session control packets on a second transmitted logical channel over the wireless link; a receiver for receiving compressed VoIP packets and uncompressed VoIP packets on a first received logical channel over the wireless link and for receiving session control packets on a second received logical channel over the wireless link.

Further embodiments provide computer readable media having computer executable instructions stored thereon, for execution by a wireless device or network device for example, that control the execution of one or more of the methods summarized above, or described below.

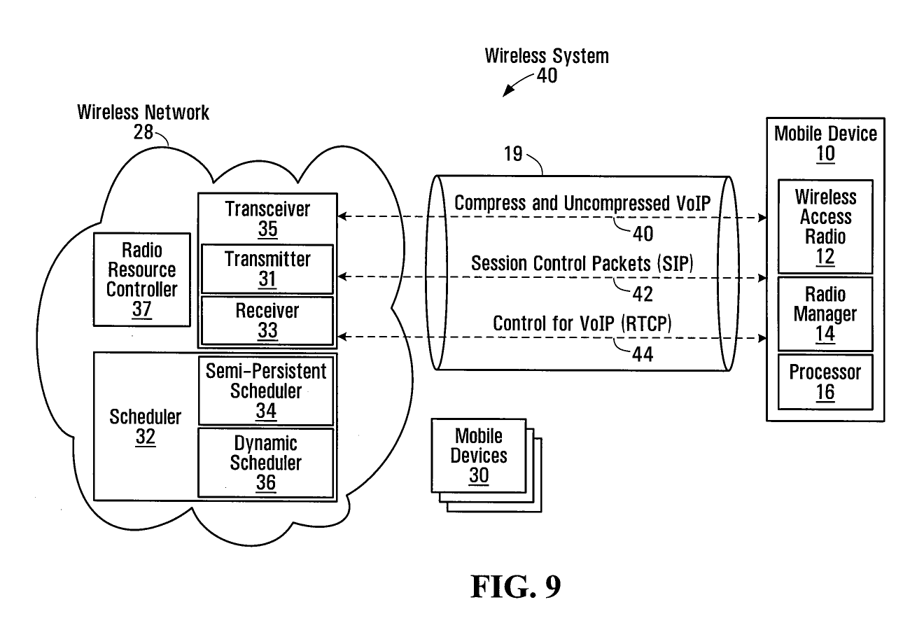

Referring now to FIG. 9, shown is a block diagram of an example wireless system 40. The wireless system 40 has a wireless network 28 and a mobile device 10. The wireless system also has other mobile devices 30.

The mobile device 10 has a wireless access radio 12 which has a transmitter and receiver (not shown), a processor 16 and a radio manager 14 that is responsible for controlling the wireless access radio 12. The mobile device 10 has at least one antenna (not shown) for communicating with the wireless network 28. There may be additional components not shown. The wireless network 28 has a transceiver 35 with transmitter 31 and receiver 33 typically both part of a base station for providing wireless access, a radio resource controller 37 for setting up logical channels as detailed below, a scheduler 32 comprising a semi-persistent scheduler 34 and a dynamic scheduler 36. The wireless network 28 has components such as base stations (not shown) for providing wireless access. The scheduler 32 may reside in the base stations or elsewhere in the network 28. For example, in the case of UTRAN Release 99, the RNC has a scheduler. In the examples that follow, it is assumed scheduler 32 is part of a base station. The wireless network 28 has at least one antenna (not shown) for communication with mobile devices 10,30.

In the illustrated example, the scheduler 32 and radio manager 14 are implemented as software and executed on processors forming part of the network 28 and mobile device 10 respectively. However, more generally, these functions may be implemented as software, hardware, firmware, or any appropriate combination thereof.

Furthermore, it is to be understood that the wireless network would have any appropriate components suitable for a wireless network 28. Note that the wireless network may include wires that interconnect network components in addition to components for providing wireless communication with mobile devices. The components of the wireless network are implementation specific and may depend on the type of wireless network. There are many possibilities for the wireless network. The wireless network might for example be a UMTS network or an LTE network.

In operation, the mobile device 10 communicates with the wireless network 28 over a wireless connection 19 between the mobile device 10 and the wireless network 28. Wireless connection 19 is depicted as a pipe as it contains several logical channels as detailed below. The communication with the wireless network 28 includes compressed VoIP packet transmission and additional packet transmission. The VoIP packets consist of transport layer packets with a payload that has been generated by a codec from samples of the speaker's voice. The additional packets include uncompressed VoIP packets, session control packets (such as SIP packets), and control packets in respect of the packets carrying VoIP packets. For the case that the transport layer is RTP such that the VoIP payload is carried in RTP packets, there may be control information that will be sent in RTCP packets. The semi-persistent scheduler function 34 is responsible for making an initial resource allocation for a VoIP service to the mobile device 10. This includes an uplink allocation and a downlink semi-persistent resource allocation. The semi-persistent scheduler 34 is also responsible for keeping track of whether there is a talk-spurt in progress for the uplink and/or the downlink and for turning on and off the uplink and downlink allocation respectively. While de-allocated, the semi-persistently allocated resources can be made available for other purposes. Note that the form of the transmission resources that are being allocated is implementation specific. Particular examples of resources that might be used include OFDM resources and CDMA resources. The session control packets typically occur at the start and at the end of the VoIP call, but they may also occur during the call, for example so as to change codec parameters.

Three pairs of logical channels are defined between the mobile device 10 and the wireless network 28 over the wireless connection 19. Each pair of logical channels includes a downlink logical channel (i.e. transmitted by the network, for example by an eNB and received by a mobile device) and an uplink logical channel (i.e. transmitted by a mobile device and received by the network. A first pair of logical channels 40 is defined for the transmission of the compressed VoIP packets and uncompressed VoIP packets. Various examples are described below. A second pair of logical channels 42 is defined for the transmission of the session control packets (such as SIP packets). A third pair of logical channels 44 is defined for the transmission of control packets in respect of the compressed VoIP packet transmission (such as RTCP).

In the description that follows, it is assumed that the session control packets are SIP packets, and that the control packets in respect of the compressed VoIP packet transmission are RTCP packets. However, it is to be clearly understood that this is an implementation decision. More generally, in other embodiments wherever SIP packets are referred to, any appropriate session control packets can be used, and wherever RTCP packets are referred to, any appropriate control packets for the compressed VoIP packet transmission can be used.

In some embodiments, each pair of logical channels is established with quality of service (QoS) parameters specific to the traffic they are carrying. Thus, the first pair of logical channels has QoS parameters selected for VoIP; the second pair of logical channels has QoS parameters selected for SIP; and the third pair of logical channels has QoS parameters selected for RTCP. More generally, each logical channel may have one or more channel-specific parameters. Examples of parameters that might be individually selected for each of these logical channels include:

RLC (Radio Link Control) connection identifier;

RLC Mode (e.g. acknowledged or unacknowledged);

RLC buffer size;

scheduling strategy;

QoS parameters(such as BLER, delay tolerance);

Maximum number of retransmission; and/or

Modulation/coding scheme.

The dynamic scheduler 36 is responsible for making resource allocations for uncompressed VoIP packet transmissions that are not accommodated by the semi-persistent resource allocation. In some embodiments or instances, the dynamic scheduler will attempt to use resources that offer the same QoS that is used for the compressed VoIP packets received from the semi-persistent scheduling function. Specific methods are described below. Such allocations can be performed for the uplink and/or the downlink.

For downlink transmission, the compressed VoIP packets and the uncompressed VoIP packets are transmitted on the same logical channel and as such compressed and uncompressed VoIP packets are in the same buffer such as a HARQ buffer. In some embodiments, the network (typically the base station/eNB) determines on a per packet basis which scheduling strategy is to be applied to each packet in the same buffer. In one implementation, a size threshold is applied to determine for each packet whether to use a semi-persistent allocation or a dynamically scheduled allocation. In some embodiments, the next higher layer (PDCP) or the compression algorithm (ROHC) indicates that a particular voice packet is an uncompressed VoIP packet as opposed to a compressed VoIP packet.

Similarly, for uplink transmission, the compressed VoIP packets and the uncompressed VoIP packets are transmitted on the same logical channel and as such compressed and uncompressed VoIP packets are in the same buffer such as a HARQ buffer. In some embodiments, the mobile device determines on a per packet basis which scheduling strategy is to be applied each packet in the same buffer. In one implementation, a size threshold is applied to determine for each packet whether to use the semi-persistent allocation or the dynamically scheduled allocation. In some embodiments, the next higher layer (PDCP) or the compression algorithm (ROHC) indicates that a particular voice packet is an uncompressed VoIP packet. In the event the dynamic scheduling is to be employed, the mobile device sends an appropriate request to the network.

In the mobile device, the radio manager 14 monitors downlink signalling to determine when an uncompressed VoIP packet transmission has been scheduled on the uplink and/or downlink. In addition, the radio manager 14 generates signalling to request capacity to transmit such an uncompressed VoIP packet on the uplink. Specific methods are described below. The radio manager 14, in cooperation with the scheduler 32 of the network, sets up the three logical channels.

In some embodiments, the pair of logical channels carrying the SIP/SDP may be established first since the SIP signalling exchange, may be required first to establish a VoIP session. The RLC connection is established between the network (for example an ENB) and the mobile device with QoS parameters for the SIP (for example, minimum BLER). The Acknowledged Mode RLC may be used for the pair of logical channels carrying the SIP/SDP to improve the reliability. After the SIP signalling exchange, the pair of logical channels of the VoIP traffic (RTP traffic) is established. A further pair of logical channels is established for VoIP control, such as for RTCP traffic.

In some embodiments, each logical channel is a respective radio bearer. In another specific example, each logical channel is a respective RLC connection. Each RLC connection/radio bearer/logical channel may have its specific QoS parameters. For example, a RLC connection/radio bearer/logical channel carrying the RTP traffic may use the Unacknowledged mode RLC while a RLC connection/radio bearer/logical channel carrying the RTCP packets may use the Acknowledged mode RLC. Further, a RLC connection/radio bearer/logical channel carrying the RTP packets may be assigned a semi-persistent resource for the packet delivery on both the uplink and the downlink. In some embodiments, the radio bearer carrying the RTCP packets will only use the dynamic scheduling. In some embodiments, a RLC connection/radio bearer/logical channel carrying RTCP packets may be assigned a different QoS from a RLC connection/radio bearer/logical channel carrying RTP traffic.

In the examples described thus far, three pairs of logical channels are established, and these include one for VoIP payload, one for session control packets, and one for packets that control the VoIP packet flow. This is assumed to be the case for the remainder of this description. However, in some embodiments, only two pairs of logical channels are established, one of which is for the VoIP payload and the other of which is for session control packets. In some embodiments where only two pairs of radio bearers are used, the radio bearers used for the VoIP payload are also used for associated control traffic (such as RTCP packets).

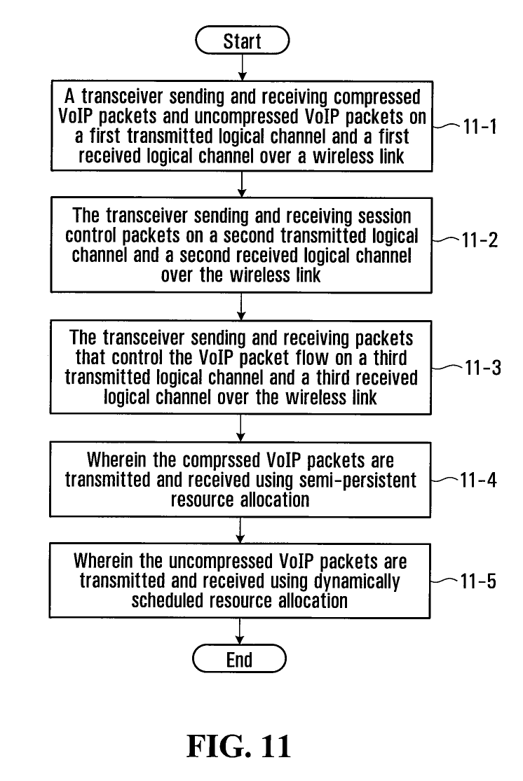

Referring now to FIG. 11, shown is a flowchart of a method of sending and receiving packets of the three types referred to above, namely VoIP packets including compressed and uncompressed, session control packets, and packets that are used to control the VoIP packet flow. The method can be applied in the network in which case the “transceiver” referred to below might, for example, be a base station. In addition, the method can be applied in a mobile device in which case the “transceiver” referred to below would be the mobile device. In addition, the method steps may be applied in respect of uplink transmission, in respect of downlink transmission, or in respect of both uplink and downlink transmission. Whether a “transmitted logical channel” refers to an uplink or downlink logical channel and whether a “received logical channel” refers to an uplink or downlink logical channel both depend on the transceiver. If the transceiver is the network, then a transmitted logical channel is a downlink logical channel, and a received logical channel is an uplink logical channel. On the other hand, if the transceiver is the mobile device, then a transmitted logical channel is an uplink logical channel, and a received logical channel is a downlink logical channel.

The method begins at step 11-1 with a transceiver sending and receiving compressed VoIP packets and uncompressed VoIP packets on a first transmitted logical channel and a first received logical channel over a wireless link. The method continues at step 11-2 with the transceiver sending and receiving session control packets on a second transmitted logical channel and a second received logical channel over the wireless link. Next, in step 11-3, the transceiver sends and receives packets that control the VoIP packet flow on a third transmitted logical channel and a third received logical channel over the wireless link. The compressed VoIP packets are transmitted and received using semi-persistent allocation as indicated at step 11-4, although this is not really a separate step. In addition, the uncompressed VoIP packets are transmitted and received using a dynamically scheduled resource allocation as indicated at steps 11-5, although this too is not really a separate step.

### Dynamic Scheduling for the Downlink

### FIRST EXAMPLE

### Dynamic Scheduling for the Downlink with Layer 1 Control Channel

In a first example, the network makes the dynamic resource allocations independently from the semi-persistent scheduling and signals this using a layer 1 control channel. In this case, a resource grant is delivered to the mobile device by a layer 1 control channel. The mobile device monitors the control channel to look for grants. Upon receipt of such a grant, the mobile device then receives content on the downlink transmission resource allocated by the grant. For this approach, the mobile device may need to monitor the Layer 1 control channel continuously as it does not know when the control channel will be used to transmit a grant. In a particular example of a layer 1 control channel, every 1 ms, a signal is broadcast by a base station for reception by all mobile devices being serviced by the particular base station. Each signal can contain a dynamic resource allocation. There will be a dynamic resource allocation for each mobile device that is being allocated an additional packet. For a given one of the control channel signals, if there are no additional resource allocations to signal, the signal will not include any allocations.

The structure of the control channel is implementation specific. A specific example of a control channel that can be used for this purpose is that defined in the Long Term Evolution (LTE) the Physical Downlink Control Channel (PDCCH) as defined in TS36.211 hereby incorporated by reference in its entirety. With the PDCCH, the control signal will be transmitted in the first L OFDM symbols in the first slot of a subframe (L<=3). Each subframe is 1 ms, and each subframe is composed of 2 slots. The PDCCH always use QPSK modulation scheme. In another example, in HSDPA the scheduling indication can be sent on HS-SCCH channel. HS-SCCH and PDCCH provide similar functions.

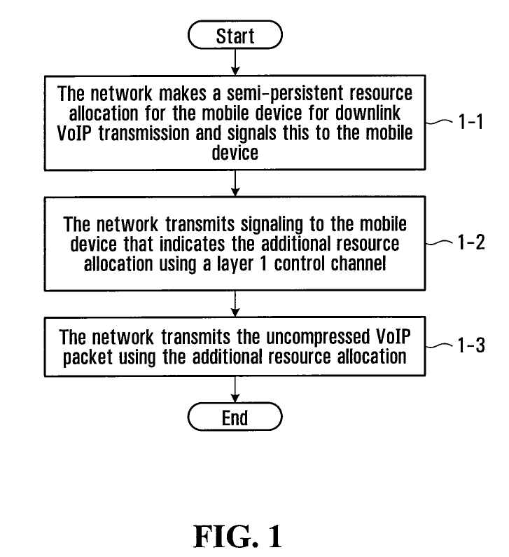

Referring to FIG. 1, shown is a flowchart of such a method from the perspective of a network providing service to a single mobile device. More generally, the network will perform such steps for each mobile device that is being provided service. At step 1-1, the network makes a semi-persistent resource allocation for the mobile device for downlink VoIP transmission and signals this to the mobile device. This is done each time a new VoIP session starts and may re-configured during the call. For the duration of a VoIP session, the network also transmits to the mobile device using the semi-persistent resource for periods that a DL talk burst is in progress. At step 1-2, the network transmits signaling to the mobile device that indicates an additional resource allocation to transmit an additional packet. This is sent using a layer 1 control channel. At step 1-3 the network transmits the additional packet using the additional resource allocation. Steps 1-2, 1-3 are performed for each additional packet that requires transmission.

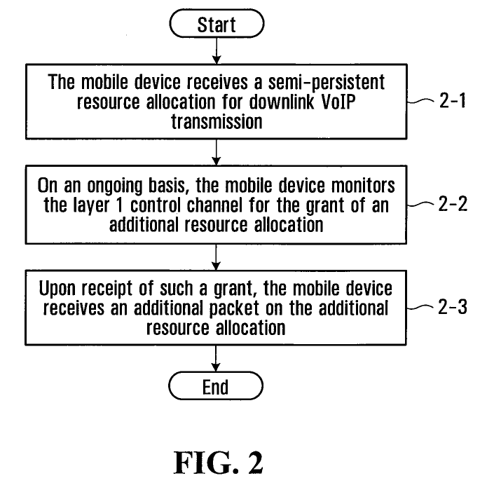

Referring to FIG. 2, shown is a flowchart of such a method from the perspective of a single mobile device. At step 2-1, the mobile device receives a semi-persistent resource allocation for downlink VoIP transmission. For the duration of a VoIP session, the mobile device also receives downlink VoIP transmissions on the semi-persistent resource during periods that a DL talk burst is in progress. At step 2-2, on an ongoing basis, the mobile device monitors the layer 1 control channel for the grant of an additional resource allocation. At step 2-3, upon receipt of such a grant, the mobile device receives an additional packet on the additional resource allocation. Step 2-3 is performed for each additional packet. Second Example: Dynamic Scheduling for the Downlink with MAC layer signaling

In a second example, the semi-persistent resource allocation and use is the same as for the first example. In addition, the network makes the dynamic resource allocations independently from the semi-persistent scheduling and signals this using MAC layer signaling. In a specific example, a downlink grant can be transmitted via MAC layer signaling that is encapsulated into the MAC header of a VoIP PDU. In this manner, the mobile device may not need to monitor the layer 1 control channel continuously. This is only for the initial transmission. If the mobile device sends back a NACK, the mobile device starts to monitor the layer 1 control channel for retransmission grants. For example, an optional field in the downlink VoIP MAC PDU header could contain the resource grant information. After the UE receives the VoIP PDU, it can obtain this optional header, and then the UE can start to receive the packets transmitted over the additionally granted resource.

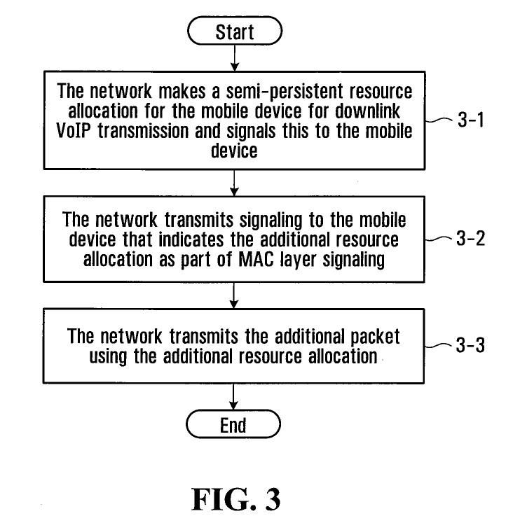

Referring to FIG. 3, shown is a flowchart of such a method from the perspective of a network providing service to a single mobile device. More generally, the network will perform such steps for each mobile device that is being provided service. At step 3-1, the network makes a semi-persistent resource allocation for the mobile device for downlink VoIP transmission and signals this to the mobile device. This might be done each time a new VoIP session starts. For the duration of a VoIP session, the network also transmits to the mobile device using the semi-persistent resource for periods that a DL talk burst is in progress. At step 3-2, the network transmits signaling to the mobile device that indicates an additional resource allocation to transmit an additional packet. This is sent as part of MAC layer signaling, for example included as part of the header of the next VoIP packet transmission to the particular mobile device. At step 3-3 the network transmits the additional packet using the additional resource allocation. Steps 3-2, 3-3 are performed for each additional packet that requires transmission.

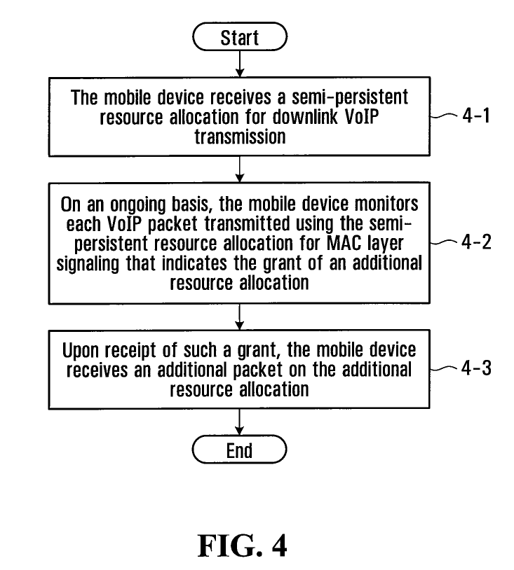

Referring to FIG. 4, shown is a flowchart of such a method from the perspective of a single mobile device. At step 4-1, the mobile device receives a semi-persistent resource allocation for downlink VoIP transmission. For the duration of a VoIP session, the mobile device also receives downlink VoIP transmissions on the semi-persistent resource during periods that a DL talk burst is in progress. At step 4-2, on an ongoing basis, the mobile device monitors each VoIP packet transmitted using the semi-persistent resource allocation for MAC layer signaling that indicates the grant of an additional resource allocation. More generally, the mobile device monitors MAC layer signaling. At step 4-3, upon receipt of such a grant, the mobile device receives an additional packet on the additional resource allocation. Step 4-3 is performed for each additional packet.

### Dynamic Scheduling for the Uplink

### FIRST EXAMPLE

### Dynamic Scheduling for the Uplink Using RACH Procedure

In a first example, dynamic scheduling for the uplink is achieved using a contention based access channel. A specific example if such a contention-based access channel is the RACH (random access channel) channel defined in TS 36.211 hereby incorporated by reference in its entirety. In order to deliver an IP packet (other than UL semi-persistent scheduled packets), the mobile device can explicitly request an additional resource from the network using the contention-based access channel. After that, the mobile device monitors the downlink layer 1 control channel for an UL grant. Once allocated, the mobile device will start the uplink transmission using the resource signaled in the grant.

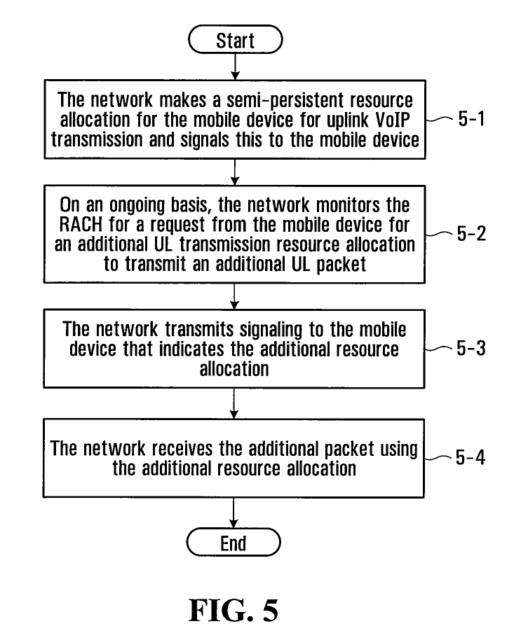

Referring to FIG. 5, shown is a flowchart of such a method from the perspective of a network providing service to a particular mobile device. At step 1-1, the network makes a semi-persistent resource allocation for the mobile device for uplink VoIP transmission and signals this to the mobile device. For the duration of a VoIP session, the network also receives from the mobile device using the semi-persistent resource for periods that a UL talk burst is in progress. At step 5-2, on an ongoing basis, the network monitors the RACH for a request from the mobile device for an additional UL transmission resource allocation to transmit an additional UL packet. More generally, the network monitors a contention-based access channel. At step 5-3, the network transmits signaling to the mobile device that indicates an additional resource allocation to transmit the additional packet. This is sent using any appropriate downlink signaling capacity. Specific examples include a downlink layer 1 control channel or MAC layer signaling as described previously for downlink allocations. At step 5-4 the network receives the additional packet using the additional resource allocation. Steps 5-2, 5-3, 5-4 are performed for each additional packet that requires transmission.

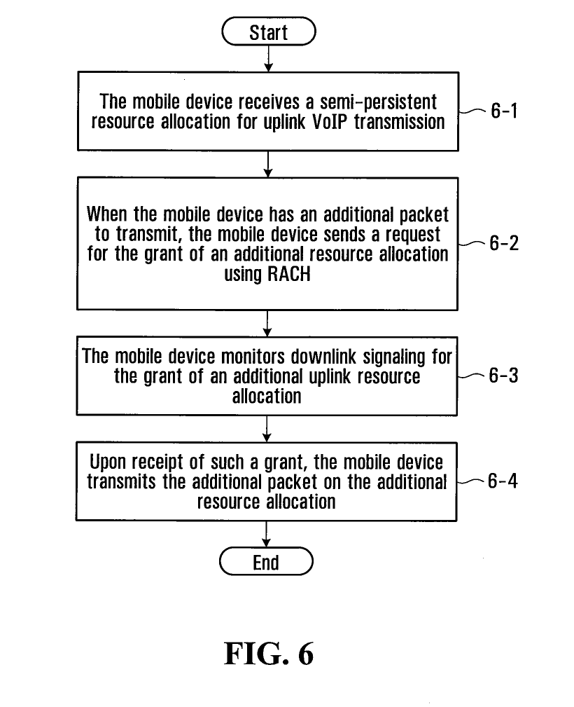

Referring to FIG. 6, shown is a flowchart of such a method from the perspective of a single mobile device. At step 6-1, the mobile device receives a semi-persistent resource allocation for uplink VoIP transmission. For the duration of a VoIP session, the mobile device also transmits uplink VoIP transmissions on the semi-persistent resource during periods that a UL talk burst is in progress. At step 6-2, when the mobile device has an additional packet to transmit, the mobile device sends a request for the grant of an additional resource allocation using RACH. More generally, the mobile device sends the request using a contention-based access channel. Given that this is a contention based channel, it is possible that several attempts may be necessary. At step 6-3, the mobile device monitors downlink signalling for the grant of an additional uplink resource allocation. This is received using any appropriate downlink signaling capacity. Specific examples include a downlink layer 1 control channel or MAC layer signaling as described previously for downlink allocations. At step 6-4, upon receipt of such a grant, the mobile device transmits the additional packet on the additional resource allocation. Steps 6-2, 6-3 and 6-4 are performed for each additional packet.

### SECOND EXAMPLE

### Dynamic Scheduling for the Uplink Using MAC Signaling

In a second example, the mobile device uses UL MAC signaling to deliver the request for an additional resource. For example, in some embodiments an optional MAC header field in the UL VoIP PDU is used to deliver the “more resource required” message, and possibly to also indicate an amount of resource required. This avoids the need for the RACH procedure described in the first example. After that, the mobile device monitors the downlink layer 1 control channel for an UL grant. Once allocated, the mobile device will start the uplink transmission using the resource signaled in the grant.

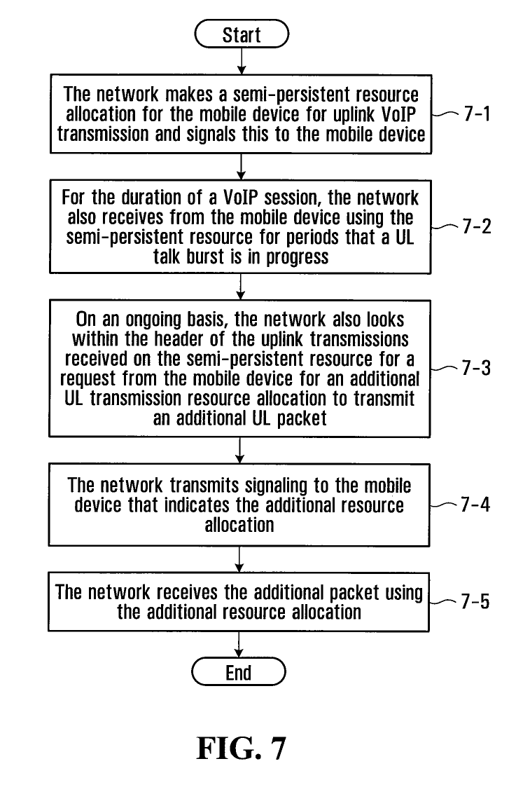

Referring to FIG. 7, shown is a flowchart of such a method from the perspective of a network providing service to a particular mobile device. At step 7-1, the network makes a semi-persistent resource allocation for the mobile device for uplink VoIP transmission and signals this to the mobile device. At step 7-2, for the duration of a VoIP session, the network also receives from the mobile device using the semi-persistent resource for periods that a UL talk burst is in progress. At step 7-3, on an ongoing basis, the network also looks within the header of the uplink transmissions received on the semi-persistent resource for a request from the mobile device for an additional UL transmission resource allocation to transmit an additional UL packet. At step 7-5, the network transmits signaling to the mobile device that indicates an additional resource allocation for the mobile device to transmit the additional packet. This is sent using any appropriate downlink signaling capacity. This may involve using a layer 1 control channel or MAC layer signaling as described previously for downlink allocation. At step 7-6 the network receives the additional packet using the additional resource allocation. Steps 7-3, 7-4, 7-5 and 7-6 are performed for each additional packet that requires transmission.

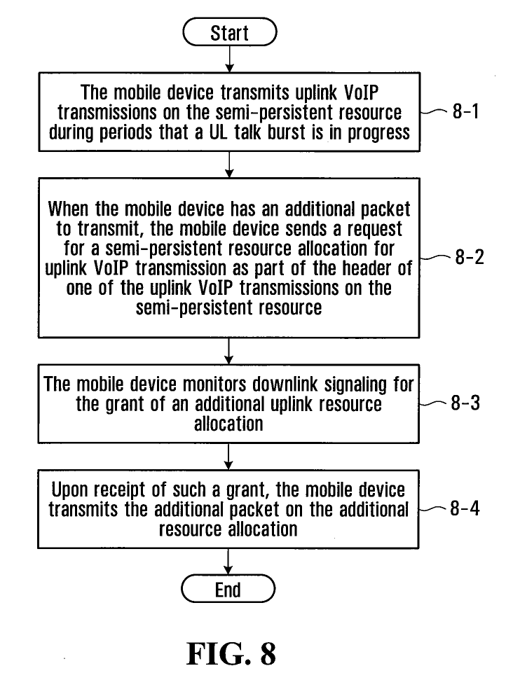

Referring to FIG. 8, shown is a flowchart of such a method from the perspective of a single mobile device. In step 8-1, for the duration of a VoIP session, the mobile device transmits uplink VoIP transmissions on the semi-persistent resource during periods that a UL talk burst is in progress. At step 8-2, when the mobile device has an additional packet to transmit, the mobile device sends a request for a semi-persistent resource allocation for uplink VoIP transmission as part of the header of one of the uplink VoIP transmission on the semi-persistent resource. At step 8-3, the mobile device monitors downlink signaling for the grant of an additional uplink resource allocation. At step 8-4, upon receipt of such a grant, the mobile device transmits the additional packet on the additional resource allocation. Steps 8-2, 8-3 and 8-4 are performed for each additional packet.

The above description has focused on applications where the traffic that is sent using the semi-persistent resource allocation is VoIP traffic. More generally, the same methods and systems can be applied to combine the transmission and scheduling of traffic of any type on a semi-persistently allocated resource with the transmission and scheduling of traffic that uses dynamic resource allocations.

In the above examples, Control Channel Elements, CCEs spaced by 1 ms are used for the downlink control channel. More generally, the downlink control channel can take any form. The only limitation is that dynamic allocations for a given mobile device take place during awake periods for the mobile device. Similarly, at least in the figures, the uplink control channel has been depicted as a contention based access channel being available at intervals spaced by 1 ms. More generally, an uplink control channel for requesting additional resource allocations can come in any form. The only limitation is that requests for dynamic allocations for uplink transmission from a given mobile device will need to be transmitted during awake periods for the mobile device.

### Another Mobile Device

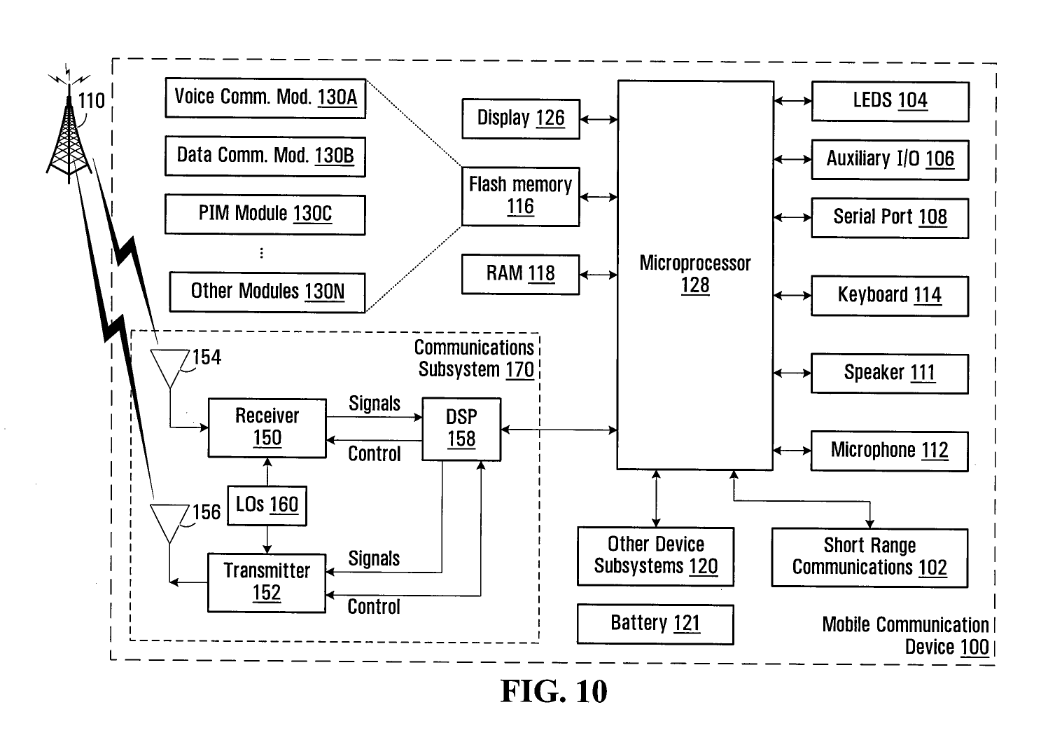

Referring now to FIG. 10, shown is a block diagram of another mobile device that may implement any of the mobile device methods described herein. The mobile device 100 is shown with specific components for implementing features similar to those of the mobile device 10 of FIG. 9. It is to be understood that the mobile device 100 is shown with very specific details for example purposes only.

A processing device (a microprocessor 128) is shown schematically as coupled between a keyboard 114 and a display 126. The microprocessor 128 may be a specific example of the processor with features similar to those of the processor 16 of the mobile device 10 shown in FIG. 9. The microprocessor 128 controls operation of the display 126, as well as overall operation of the mobile device 100, in response to actuation of keys on the keyboard 114 by a user.

The mobile device 100 has a housing that may be elongated vertically, or may take on other sizes and shapes (including clamshell housing structures). The keyboard 114 may include a mode selection key, or other hardware or software for switching between text entry and telephony entry.

In addition to the microprocessor 128, other parts of the mobile device 100 are shown schematically. These include: a communications subsystem 170; a short-range communications subsystem 102; the keyboard 114 and the display 126, along with other input/output devices including a set of LEDS 104, a set of auxiliary I/O devices 106, a serial port 108, a speaker 111 and a microphone 112; as well as memory devices including a flash memory 116 and a Random Access Memory (RAM) 118; and various other device subsystems 120. The mobile device 100 may have a battery 121 to power the active elements of the mobile device 100. The mobile device 100 is in some embodiments a two-way radio frequency (RF) communication device having voice and data communication capabilities. In addition, the mobile device 100 in some embodiments has the capability to communicate with other computer systems via the Internet.

Operating system software executed by the microprocessor 128 is in some embodiments stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device 100 may also be stored to the RAM 118.

The microprocessor 128, in addition to its operating system functions, enables execution of software applications on the mobile device 100. A predetermined set of software applications that control basic device operations, such as a voice communications module 130A and a data communications module 130B, may be installed on the mobile device 100 during manufacture. In addition, a personal information manager (PIM) application module 130C may also be installed on the mobile device 100 during manufacture. The PIM application is in some embodiments capable of organizing and managing data items, such as e-mail, calendar events, voice mails, appointments, and task items. The PIM application is also in some embodiments capable of transmitting and receiving data items via a wireless network 110. In some embodiments, the data items managed by the PIM application are seamlessly integrated, synchronized and updated via the wireless network 110 with the device user's corresponding data items stored or associated with a host computer system. As well, additional software modules, illustrated as another software module 130N, may be installed during manufacture. One or more of the modules 130A,130B,130C,130N of the flash memory 116 can be configured for implementing features similar to those of the radio manager 14 of the mobile device 10 shown in FIG. 9.

Communication functions, including data and voice communications, are performed through the communication subsystem 170, and possibly through the short-range communications subsystem 102. The communication subsystem 170 includes a receiver 150, a transmitter 152 and one or more antennas, illustrated as a receive antenna 154 and a transmit antenna 156. In addition, the communication subsystem 170 also includes a processing module, such as a digital signal processor (DSP) 158, and local oscillators (LOs) 160. The communication subsystem 170 having the transmitter 152 and the receiver 150 is an implementation of a specific example of the wireless access radio 12 of the mobile device 10 shown in FIG. 9. The specific design and implementation of the communication subsystem 170 is dependent upon the communication network in which the mobile device 100 is intended to operate. For example, the communication subsystem 170 of the mobile device 100 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access (CDMA), Personal Communications Service (PCS), Global System for Mobile Communications (GSM), etc. The communication subsystem 170 may also be designed to operate with an 802.11 Wi-Fi network, and/or an 802.16 WiMAX network. Other types of data and voice networks, both separate and integrated, may also be utilized with the mobile device 100.

Network access may vary depending upon the type of communication system. For example, in the Mobitex™ and DataTAC™ networks, mobile devices are registered on the network using a unique Personal Identification Number (PIN) associated with each device. In GPRS networks, however, network access is typically associated with a subscriber or user of a device. A GPRS device therefore typically has a subscriber identity module, commonly referred to as a Subscriber Identity Module (SIM) card, in order to operate on a GPRS network.

When network registration or activation procedures have been completed, the mobile device 100 may send and receive communication signals over the communication network 110. Signals received from the communication network 110 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 110 are processed (e.g., modulated and encoded) by the DSP 158 and are then provided to the transmitter 152 for digital to analog conversion, frequency up conversion, filtering, amplification and transmission to the communication network 110 (or networks) via the transmit antenna 156.

In addition to processing communication signals, the DSP 158 provides for control of the receiver 150 and the transmitter 152. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 170 and is input to the microprocessor 128. The received signal is then further processed by the microprocessor 128 for an output to the display 126, or alternatively to some other auxiliary I/O devices 106. A device user may also compose data items, such as e-mail messages, using the keyboard 114 and/or some other auxiliary I/O device 106, such as a touchpad, a rocker switch, a thumb-wheel, or some other type of input device. The composed data items may then be transmitted over the communication network 110 via the communication subsystem 170.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the mobile device 100. In addition, the display 126 may also be utilized in voice communication mode, for example, to display the identity of a calling party, the duration of a voice call, or other voice call related information.

The short-range communications subsystem 102 enables communication between the mobile device 100 and other proximate systems or devices, which need not necessarily be similar devices. For example, the short-range communications subsystem may include an infrared device and associated circuits and components, or a Bluetooth™ communication module to provide for communication with similarly-enabled systems and devices.

Numerous modifications and variations of the present invention are possible in light of the above teachings. It is therefore to be understood that within the scope of the appended claims, the invention may be practiced otherwise than as specifically described herein.

We claim:

1. A method comprising:
sending and receiving compressed VoIP packets and uncompressed VoIP packets on a first transmitted logical channel and a first received logical channel over a wireless link;
sending and receiving session control packets on a second transmitted logical channel and a second received logical channel over the wireless link;
wherein sending and receiving the compressed VoIP packets utilizes semi-persistent resource allocation; and
wherein sending and receiving uncompressed VoIP packets utilizes dynamically scheduled resource allocation.

2. The method of claim 1 further comprising:
sending and receiving control packets in respect of VoIP packets.

3. The method of claim 1 wherein sending and receiving control packets in respect of VoIP packets comprises:
sending and receiving control packets in respect of VoIP packets on the first transmitted logical channel and the first received logical channel over the wireless link.

4. The method of claim 1 wherein sending and receiving control packets in respect of VoIP packets comprises:
sending and receiving control packets in respect of VoIP packets on a third transmitted logical channel and a third received logical channel over the wireless link.

5. The method of claim 1 wherein the each logical channel is a respective radio bearer or a respective RLC connection.

6. The method of claim 4 wherein the each logical channel is a respective radio bearer or a respective RLC connection.

7. The method of claim 1 wherein the compressed VoIP packets are sent and received as payload of RTP packets, the session control packets comprise SIP packets.

8. The method of claim 2 wherein the packets that control the first logical channel comprise RTCP packets.

9. The method of claim 1 wherein the sending and receiving actions are all executed by a mobile device.

10. The method of claim 1 wherein the sending and receiving actions are all executed by a network.

11. The method of claim 10 wherein the sending compressed VoIP packets and uncompressed VoIP packets on a first transmitted logical channel over a wireless link comprises:
making a semi-persistent resource allocation for a mobile device for downlink transmission and signaling the semi-persistent resource allocation from the network to the mobile device;
transmitting packets from the network to the mobile device using the semi-persistent resource allocation;
determining at the network an additional dynamic resource allocation to transmit an uncompressed VoIP packet;
transmitting from the network signaling to the mobile device that indicates the additional dynamic resource allocation; and
transmitting from the network the uncompressed VoIP packet using the additional dynamic resource allocation.

12. The method of claim 9 wherein the receiving compressed VoIP packets and uncompressed VoIP packets on a first received logical channel over a wireless link comprises:
receiving at the mobile device a semi-persistent resource allocation for downlink packet transmission;
receiving at the mobile device downlink packet transmissions on the semi-persistent resource;
on an ongoing basis, monitoring at the mobile device downlink signaling for a grant of an additional resource allocation; and
upon receipt of such a grant, receiving at the mobile device an uncompressed VoIP packet on the additional resource allocation.

13. The method of claim 10 wherein receiving compressed VoIP packets and uncompressed VoIP packets on a first received logical channel over a wireless link comprises:
making a semi-persistent resource allocation at the network for the mobile device for uplink transmission and signaling this to the mobile device;
receiving at the network packets from the mobile device using the semi-persistent resource allocation;
on an ongoing basis, monitoring at the network for uplink signaling from the mobile device containing a request for an additional uplink transmission resource allocation to transmit an additional uplink packet;
determining at the network an additional dynamic uplink resource allocation for the mobile device to transmit the uncompressed VoIP packet;
transmitting from the network signaling to the mobile device that indicates the additional dynamic resource allocation; and
receiving at the network the uncompressed VoIP packet using the additional dynamic resource allocation.

14. The method of claim 9 wherein sending compressed VoIP packets and uncompressed VoIP packets on a first transmitted logical channel over a wireless link comprises:
receiving at the mobile device a semi-persistent resource allocation for uplink packet transmission;
transmitting packets from the mobile device on the semi-persistent resource allocation;
when the mobile device has an uncompressed VoIP packet to transmit, transmitting a request from the mobile device for the grant of an additional resource allocation using uplink signaling;
monitoring at the mobile device downlink signaling for a grant of an additional uplink resource allocation;
upon receipt of such a grant, transmitting from the mobile device the uncompressed VoIP packet on the additional resource allocation.

15. An apparatus comprising:
a transmitter for transmitting compressed VoIP packets and uncompressed VoIP packets on a first transmitted logical channel over a wireless link and for transmitting session control packets on a second transmitted logical channel over the wireless link;
a receiver for receiving compressed VoIP packets and uncompressed VoIP packets on a first received logical channel over the wireless link and for receiving session control packets on a second received logical channel over the wireless link.

16. The apparatus of claim 15 wherein:
the transmitter and receiver are further configured to transmit and receive control packets in respect of VoIP packets.

17. The apparatus of claim 16 wherein the control packets in respect of VoIP packets are transmitted on the first transmitted logical channel and received on the first received logical channel over the wireless link.

18. The apparatus of claim 16 wherein:
the transmitter is further configured to send control packets in respect of VoIP packets on the third transmitted logical channel;
the receiver is further configured to receive control packets in respect of VoIP packets on the third received logical channel.

19. The apparatus of claim 15 further comprising:
a radio resource controller for setting up the first transmitted logical channel, the first received logical channel, the second transmitted logical channel and the second received logical channel over the wireless link;
a scheduler comprising:
a) a semi-persistent scheduler for scheduling compressed VoIP packets for transmission on the first transmitted logical channel and reception on the first received logical channel using semi-persistent resource allocation;
b) a dynamic scheduler for scheduling uncompressed VoIP packets for transmission on the second transmitted logical channel and reception on the second received logical channel using dynamically scheduled resource allocation.

20. The apparatus of claim 19 wherein the radio resource controller is further configured to setup a third transmitted logical channel and a third received logical channel over the wireless link;
the transmitter is further configured to send control packets in respect of VoIP packets on the third transmitted logical channel;
the receiver is further configured to receive control packets in respect of VoIP packets on the third received logical channel.

21. The method of claim 11 wherein:
transmitting signaling to the mobile device that indicates the additional resource allocation comprises using a layer 1 control channel;
transmitting signaling to the mobile device that indicates the additional resource allocation comprises using MAC layer signaling.

22. The method of claim 21 wherein transmitting signaling using MAC layer signaling comprises transmitting an optional field in one of the packets transmitted using the semi-persistent resource allocation.

23. The method of claim 12 wherein on an ongoing basis, monitoring downlink signaling for a grant of an additional resource allocation comprises monitoring at least one of:
a layer 1 control channel;
MAC layer signaling.

24. The method of claim 13 wherein on an ongoing basis, monitoring at the network for uplink signaling from the mobile device containing a request for an additional uplink transmission resource allocation to transmit an additional uplink packet comprises monitoring at least one of:
a contention-based access channel;
a random access channel;
MAC layer signaling.

25. The method of claim 13 wherein on an ongoing basis, monitoring at the network for uplink signaling from the mobile device containing a request for an additional uplink transmission resource allocation to transmit an additional uplink packet comprises monitoring at least one of:
a contention-based access channel;
a random access channel;
MAC layer signaling.
